(19) United States
(12) Patent Application Publication
(10) Pub. No.: US 2024/0169019 A1
(43) Pub. Date: May 23, 2024

(54) PERFORMANCE IN SPARSE MATRIX VECTOR (SpMV) MULTIPLICATION USING ROW SIMILARITY

(71) Applicant: Advanced Micro Devices, Inc., Santa Clara, CA (US)

(72) Inventors: ANTHONY GUTIERREZ, Bellevue, WA (US); ALI ARDA EKER, Bellevue, WA (US)

(21) Appl. No.: 17/991,493

(22) Filed: Nov. 21, 2022

(51) Int. Cl. G06F 17/16

(52) U.S. Cl. CPC G06F 17/16

(57) ABSTRACT

A technical solution to the technical problem of how to improve performance when performing SpMV multiplication uses sparse matrix row similarity to schedule SpMV multiplication operations. CSR representation metadata is generated for a CSR representation and indicates the locations of non-zero values in the rows of the corresponding sparse matrix or the cache locations of column data needed for SpMV multiplication operations. The CSR representation metadata is used to determine the similarity of rows in the sparse matrix based upon Cosine similarity, Jaccard similarity, Locality Sensitive Hashing (LSH) that approximates Jaccard similarity, or other measures of similarity. The row similarity is used to schedule SpMV multiplication operations to increase data locality, reduce cache misses, reduce time stalling on memory accesses, and reduce bandwidth consumption. Implementations include the use of similarity thresholds to schedule SpMV multiplication operations on particular threads and processing elements and load balancing to further improve performance.

This invention was made with U.S. Government support under Contract No. H98230-22-C-0152 awarded by the Department of Defense. The U.S. Government has certain rights in this invention.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Sparse matrix vector (SpMV) multiplication is a fundamental computational kernel used in many scientific and engineering applications, such as graph analytics, graphics processing, numerical analysis, and machine learning. One of the issues with SpMV multiplication is that the large number of zeros and irregular data patterns in a sparse matrix can cause inefficient bandwidth and cache use. Various sparse matrix representations have emerged to improve bandwidth and cache use efficiency, such as the industry-standard Compressed Sparse Row (CSR) representation. While the CSR representation reduces the size of a sparse matrix and provides a more regular data pattern, the column access patterns can be irregular, which can cause a significant number of cache misses, time stalling on memory accesses, and increased bandwidth consumption.

One of the approaches for addressing the limitations of the CSR representation uses a large number of threads, or wavefronts and/or warps on Graphics Processing Units (GPUs), to perform the matrix multiplication operations to overcome latency. Tiling strategies can also be used to tile a sparse input matrix into denser chunks to improve data locality and caching efficiency, but tiling strategies do not provide a significant improvement in performance when the sparsity is non-uniform, because this may require non-uniform tile sizes. Tiling strategies also require additional reductions to reduce values computed across tiles. Yet other approaches take advantage of matrix structure, such as in triangular or symmetric matrices, but not all matrices have such structure. Finally, some approaches use the Compressed Sparse Column (CSC) format and outer product that can improve data locality when there is less column sparsity. This approach, however, requires more complex reductions operations. In addition, the approach can be less effective for matrices that are hyper sparse or that have irregular distributions of non-zero values.

There is, therefore, a need for a technical solution to the technical problem of how to improve performance when using CSR representations to perform SpMV multiplication.

### BRIEF DESCRIPTION OF THE DRAWINGS

Implementations are depicted by way of example, and not by way of limitation, in the figures of the accompanying drawings and in which like reference numerals refer to similar elements.

FIG. 1 depicts an example computing architecture that includes a processor communicatively coupled to a memory via a memory interface.

FIG. 2A depicts an example sparse matrix A in the form of a five by five array.

FIG. 2B depicts a CSR representation for a sparse matrix.

FIG. 2C depicts example CSR representation metadata for a sparse matrix A.

FIG. 2D depicts row similarity based upon the Cosine similarity calculated using the CSR representation metadata of FIG. 2C.

FIG. 2E depicts row similarity based upon the Jaccard similarity calculated using the CSR representation metadata for the sparse matrix A of FIG. 2C.

FIG. 2F depicts example CSR representation metadata for the sparse matrix A that indicates whether the value in each cell in the sparse matrix A is a non-zero value or a zero value and if a non-zero value, a location in cache where the non-zero value is stored.

FIG. 2G depicts how using LSH to determine the similarity between two sets of data approximates the Jaccard similarity.

FIG. 3 is a flow diagram that depicts a Locality Sensitive Hashing (LSH) approach for determining sparse matrix row similarity.

FIG. 4A depicts example CSR representation metadata for a selected row of a sparse matrix, a corresponding set of permutations, and a row signature.

FIG. 4B depicts signature vectors for four rows and using four bands to compare signatures.

FIG. 4C depicts signature vectors for four rows and using two bands to compare signatures.

FIG. 5 is a flow diagram that depicts an approach for performing SpMV multiplication using sparse matrix row similarity.

### DETAILED DESCRIPTION

In the following description, for the purposes of explanation, numerous specific details are set forth in order to provide a thorough understanding of the implementations. It will be apparent, however, to one skilled in the art that the implementations may be practiced without these specific details. In other instances, well-known structures and devices are shown in block diagram form in order to avoid unnecessarily obscuring the implementations.
I. Overview
II. Architecture
III. Modified CSR Representation Approach
   A. Introduction
   B. CSR Representation Metadata
   C. Row Similarity
   D. Determining Row Similarity Using Locality Sensitive Hashing (LSH)
   E. Using Row Similarity to Improve Performance

### I. Overview

A technical solution to the technical problem of how to improve performance when performing SpMV multiplication uses sparse matrix row similarity to schedule SpMV multiplication operations. CSR representation metadata is generated for a CSR representation and indicates the locations of non-zero values in the rows of the corresponding sparse matrix or the cache locations of column data needed for SpMV multiplication operations. The CSR representation metadata is used to determine the similarity of rows in the sparse matrix based upon Cosine similarity, Jaccard similarity, Locality Sensitive Hashing (LSH) that approximates Jaccard similarity, or other measures of similarity. The row similarity is used to schedule SpMV multiplication operations to increase data locality, reduce cache misses, reduce time stalling on memory accesses, and reduce bandwidth consumption. Implementations include the use of similarity thresholds to schedule SpMV multiplication operations on particular threads and processing elements, and load balancing to further improve performance.

### II. Architecture

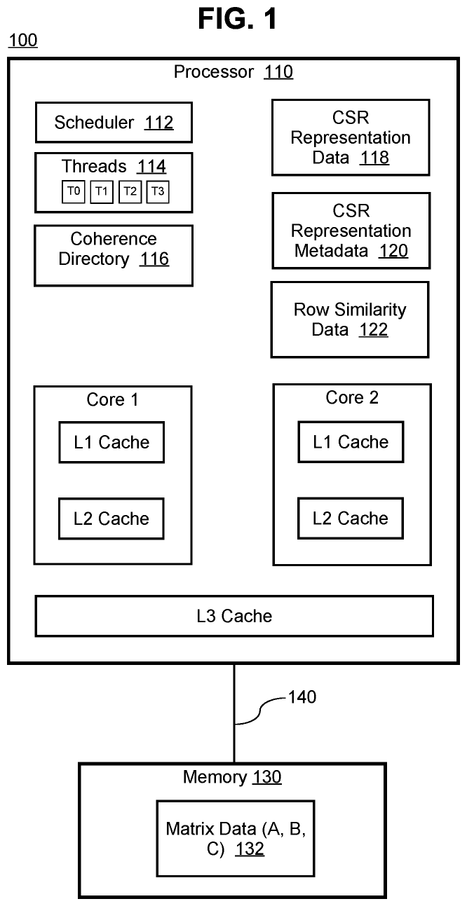

FIG. 1 depicts an example computing architecture 100 that includes a processor 110 communicatively coupled to a memory 130, for example via a memory interface 140. The processor 110 is any type of processor, such as a Central Processing Unit (CPU), a Graphics Processing Unit (GPU), an Application-Specific Integrated Circuit (ASIC), a System on a Chip (SoC), etc. The memory 130 is any type of memory, such as a Dynamic Random Access Memory (DRAM) or a Processor-In-Memory (PIM)-enabled memory, such as one or more PIM-enabled DRAM modules. As depicted in FIG. 1, the memory 130 stores matrix data 132 that is used in SpMV multiplication operations, as described in more detail hereinafter.

The processor 110 includes two cores, identified in FIG. 1 as “Core 1” and “Core 2,” but implementations are not limited to processors with any particular number of cores and may have a single core or more than two cores. In the example of FIG. 1, each core includes a private level 1 (L1) and level 2 (L2) cache, and the two cores also share a level 3 (L3) cache, which in this example is the last level cache. The L2 cache is depicted in FIG. 1 as a private cache to Core 1 and Core 2, but implementations are applicable to L2 caches that are shared by multiple cores. Each of the caches L1, L2, L3 includes a cache controller that is not depicted in the figures for purposes of explanation. Implementations are not limited to the cache structure depicted in FIG. 1 and are applicable to any type of cache structure including, for example, cache structures with fewer or additional caches of any type and size. In addition, although multi-core microprocessors are commonly implemented with the same cache structure, i.e., the same type and size of L1 and L2 cache, implementations are not limited to this context and are applicable to cores have different cache structures. Implementations are also applicable to non-cache-based processors. The processor 110 includes other elements that are not depicted in the figures or described herein for purposes of explanation, such as a memory controller, an Arithmetic and Logical Unit (ALU), buffers, data, address, control buses, etc., that vary depending upon a particular implementation.

The processor 110 also includes a scheduler 112 and threads 114. Examples are described herein in the context of four threads T0-T3, but implementations are applicable to processors 110 with any number of threads and also non-threading processors. The scheduler 112 schedules execution of the threads 114 and operations performed by the threads 114. As described in more detail hereinafter, the scheduler 112 is configured to group together SpMV multiplication operations for similar rows in one or more matrices. The scheduler 112 is implemented by one or more hardware elements, one or more software elements including firmware, or any computer of hardware elements and software elements.

The processor 110 further includes a coherence directory 116 that is used to manage and maintain cache coherence on the processor 110. The coherence directory 116 may be implemented by any cache coherence mechanism and include, for example, storage for storing cache line information and processing logic for implementing a cache coherence algorithm.

### III. Modified CSR Representation Approach

A. Introduction

According to an implementation, the processor 110 loads from the memory 130 one or more portions of the matrix data 132, which may include all of the matrix data 132, and generates CSR representation data 118 that may be stored on the processor 110 for example, in one or more registers or one or more caches, or external to the processor 110, for example in the memory 130 or on another element.

Although implementations are described herein in the context of the processor 110 generating CSR representations, implementations are not limited to the processor 110 generating the CSR representations and the CSR representations may be generated by elements external to the processor 110 and the resulting CSR representation data 118 made available to the processor 110. In addition, implementations are not limited to CSR representations and are applicable to other sparse matrix representations, such as a List of Lists.

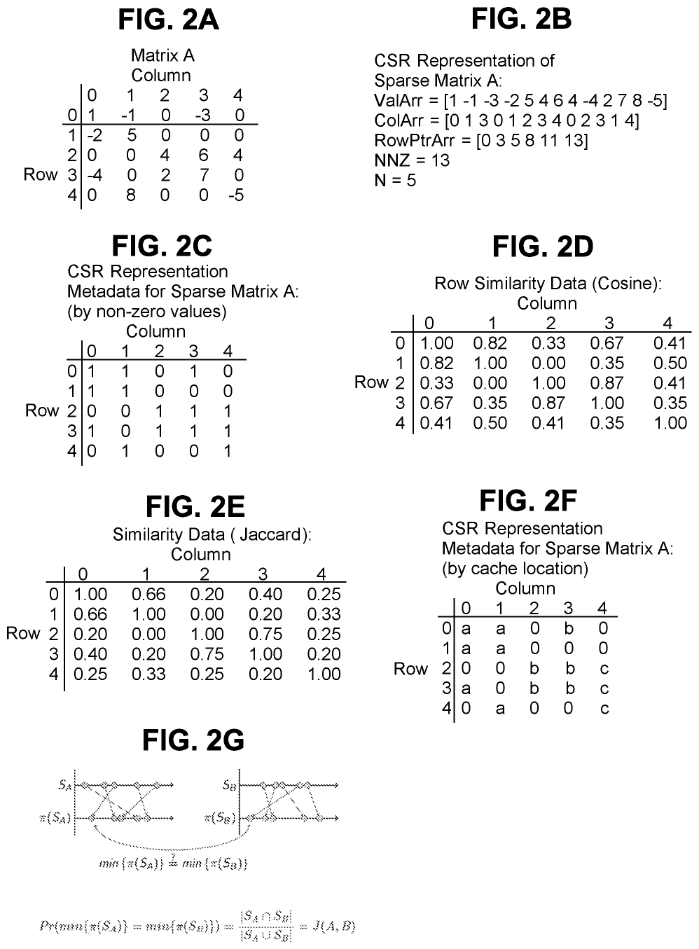

As depicted in FIG. 1, the matrix data 132 includes matrices A, B, and C, where C=AB for example, and matrix A is a sparse matrix. FIG. 2A depicts an example sparse matrix A in the form of a five by five array (rows 0-4, columns 0-4). In practice the sparse matrix A may have many thousands of rows and columns with a large percentage of the values being zero, as is characteristic of sparse matrices. FIG. 2B depicts a CSR representation for sparse matrix A that includes arrays ValArr, ColArr, RowPtrArr, and values Number of Non-Zeros (NNZ) and number of rows (N).

B. CSR Representation Metadata

According to an implementation, the processor 110 generates, for the sparse matrix A, CSR representation metadata 120 that specifies one or more attributes of the CSR representation for the sparse matrix A. The CSR representation metadata 120 is generated, for example, during generation of the CSR representation for sparse matrix A. FIG. 2C depicts example CSR representation metadata for the sparse matrix A that indicates whether the value in each cell in the sparse matrix A is a non-zero value or a zero value. In the example of FIG. 2C, a “1” indicates a non-zero value in the corresponding cell of the sparse matrix A and a “0” indicates a zero value in the corresponding cell of the sparse matrix A. Implementations are not limited to the encoding example depicted in FIG. 2C and are applicable to other encoding methods and/or representations. The CSR representation metadata 120 may be stored on the processor 110, for example, in one or more registers or one or more caches, or may be stored external to the processor, for example in the memory 130 or on another element.

C. Row Similarity

According to an implementation, the processor 110 generates row similarity data 122 based upon the CSR representation metadata 120. The row similarity data 122 indicates the similarity of one or more rows in a sparse matrix, i.e., sparse matrix A in the present example. This may include similarity between rows in one or more subsets of rows in the sparse matrix A, or similarity between all of the rows in the sparse matrix A. The row similarity data 122 is used to identify similar rows and the processor 110 groups together SpMV multiplication operations for similar rows for scheduling purposes to improve performance. The row similarity data 122 is depicted in the figures and described herein as being separate from the CSR representation metadata 120 for purposes of explanation, but the row similarity data 122 may be included in and/or combined with the CSR representation metadata 120.

According to an implementation, the similarity between rows is based upon the locations of non-zero values within the rows and more specifically, the column locations of non-zero values within rows. Rows that have a greater number of non-zero values in the same column(s) are considered to be more similar than rows that have a fewer number of non-zero values in the same column(s). For example, referring to FIG. 2C, rows 0 and 1 have non-zero values in columns [0, 1, 3] and [0, 1], respectively. When multiplying sparse matrix A and matrix B, the column data for columns 0, 1, and 3 of matrix B can be loaded by the processor 110, stored in one or more caches on the processor 110, if available, and used for the SpMV multiplication operations for both rows 0 and 1 of sparse matrix A. Similarly, rows 2 and 3 have non-zero values in columns [2, 3, 4] and [0, 2, 3, 4], respectively. When multiplying sparse matrix A and matrix B, the column data for columns 0, 2, 3, and 4 of matrix B can be loaded by the processor 110 and used for the SpMV multiplication operations for rows 2 and 3 of sparse matrix A. In contrast, rows 1 and 2 have non-zero values in columns [0, 1] and [2, 3, 4], respectively. Thus, the processor 110 will need to load completely different column data to perform the SpMV multiplication operations for rows 1 and 2. This similarity information is leveraged, as described in more detail hereinafter, to improve performance by grouping together multiplication operations for similar rows in a sparse matrix to improve data reuse, reduce cache misses, reduce time stalling on memory accesses, and reduce bandwidth consumption. Implementations are not limited to determining row similarity based upon column IDs and as described in more detail hereinafter, in some implementations row similarity is determined based upon cache line accesses.

The similarity between rows in a sparse matrix is determined using a variety of methods that vary depending upon a particular implementation. According to an implementation, the similarity between rows is determined based the CSR representation metadata for a sparse matrix. FIG. 2D depicts row similarity based upon the Cosine similarity calculated using the CSR representation metadata of FIG. 2C. In this example, the similarity for row pairs ranges from lowest (0.00) to highest (1.00), with rows 2 and 3 having the highest similarity (0.87) between rows and rows 0 and 2 having the lowest similarity (0.33). According to another implementation, the similarity between rows is determined based upon the CSR representation for a sparse matrix. FIG. 2E depicts row similarity based upon the Jaccard similarity calculated using the CSR representation metadata for the sparse matrix A of FIG. 2C.

Situations may arise where grouping together multiplication operations for similar rows in the manner previously described does not provide the expected performance benefits because the column data is too large to store in a single storage element, e.g., a single cache line. For example, an entire column of matrix data may be too large to be stored in a single cache line and has to be stored across multiple cache lines. Continuing with the prior example, suppose that sparse matrix A and matrix B are being multiplied and that an entire column of data for matrix B cannot be stored in a single cache line. In this situation, the column data for even highly similar rows is not available in a single cache line. For example, suppose that a row pair 0, N of the sparse matrix A both contain non-zero values in the exact same columns and are therefore considered to be highly similar rows, i.e., row 0 is considered to be highly similar to row N based upon the locations of non-zero values. Suppose further that N number of column data elements for one of these columns cannot be stored in a single cache line. In this situation, grouping together the SpMV multiplication operations for rows 0 and N does not necessarily avoid a cache miss, and the corresponding overhead, because while the 0^{th} data element in the column may be in a cache line on the processor 110, the Nth data element in the column cannot be in the same cache line and is not necessarily in any cache line in cache. When the Nth column data element is not cached, this results in a cache miss and the Nth column data element (and likely other column data elements) must be loaded from the memory 130. So, while the similarity approach discussed above can provide significant performance benefits when matrix data is stored in, for example, a scratch pad memory, a register file, or other similar structure, the performance benefits may not be realized when matrix data is cached on the processor 110.

Therefore, according to another implementation, the similarity between rows is based upon locations in cache where column data is stored. FIG. 2F depicts example CSR representation metadata for the sparse matrix A that indicates whether the value in each cell in the sparse matrix A is a non-zero value or a zero value and if a non-zero value, a location in cache where the corresponding column data for matrix B is stored. In this example, the letters “a” through “c” are cache line identifiers that refer to a particular cache line on the processor 110, which may be in any of the (including more than one) caches L1, L2, L3. The cache line identifiers are described herein in the context of letters “a” through “c” for purposes of explanation, but any type of cache line identifier may be used. Cache line identifiers are determined by, for example, using mapping data that maps addresses to cache lines or by consulting the coherency directory 116. Also, in this example, for purpose of explanation each cache line can store a maximum of two column data values but in practice cache lines may store more column values. Given the cache line size of two data values, cache line “a” stores the first two data values in the column of matrix B, cache line “b” stores the next two data values in the column of matrix B, cache line “c” stores the next two data values in the column of matrix B, and so on.

Continuing with the prior example where a sparse matrix A is being multiplied with matrix B, the dot product of each row of matrix A and a column of matrix B is determined. As depicted in FIG. 2F, when calculating the dot product of row 0 of matrix A and the column of matrix B, the column data in matrix B for the first two non-zero values in row 0 of matrix A is stored in cache line “a” while the column data in matrix B for the third non-zero value in row 0 of matrix A is stored in cache line “b.” This is because in this example each cache line stores a maximum of two column data values from matrix B.

According to an implementation, the more cache line accesses that rows have in common, the more similar they are. As depicted in FIG. 2F, rows 0 and 1 reference two of the same cache lines and rows 2 and 3 reference three of the same cache lines. In contrast, rows 0 and 4 reference only one of the same cache lines. Thus, according to this implementation, row pairs 0,1 and 2,3 are considered more similar than row pair 0,4 and are more likely to be scheduled together, as described in more detail hereinafter. One advantage of this approach is that the technical benefits described herein are realized irrespective of the caching methodology used, i.e., the size or location of cache lines, or how column data is mapped to cache lines.

D. Determining Row Similarity Using Locality Sensitive Hashing (LSH)

Determining sparse matrix row similarity can be computationally expensive, especially when a sparse matrix has a large number of rows and the similarity for each row is determined for every other row in the sparse matrix. According to an implementation, row similarity is determined using Locality Sensitive Hashing (LSH) that approximates the Jaccard similarity at a lower computational cost, e.g., O(N) instead of O(N\hat{ }2), where N is the number of rows in the sparse matrix. This greatly reduces the computational cost on large data sets, i.e., large sparse matrices. LSH is described in “On the resemblance and containment of documents” by Andrei Z. Broder, the contents of which are hereby incorporated by reference for all purposes. FIG. 2G depicts how using LSH to determine the similarity between two sets of data approximates the Jaccard similarity.

The LSH approach involves generating a signature for each row in the sparse matrix. The signature is a compact and computationally efficient representation of a sparse matrix row that is generated by processing a row using two or more permutation functions to generate a corresponding number of permutations. A value is selected from each permutation and used as the corresponding value in the signature, as described in more detail hereinafter. Using a greater number of permutation functions increases the size of the signature and accuracy, but comes with increased computational cost. Rows with matching signatures are more likely to be similar so according to an implementation, the signatures are compared to identify clusters, e.g., groups, of similar rows.

According to an implementation, a sampling technique referred to herein as “banding” is used to compare signatures. With the banding technique, bands, i.e., portions of signatures, are compared to identify clusters of similar rows. Similar rows have the same value(s) within the bands of their respective signature. The clusters of similar rows are sorted using sort criteria to create a sorted hierarchy of clusters, from most similar to less similar. The sorted clusters are then used to rearrange rows in the CSR representation 118 and/or used in scheduling SpMV multiplication operations. The approach is described in more detail hereinafter with respect to various figures.

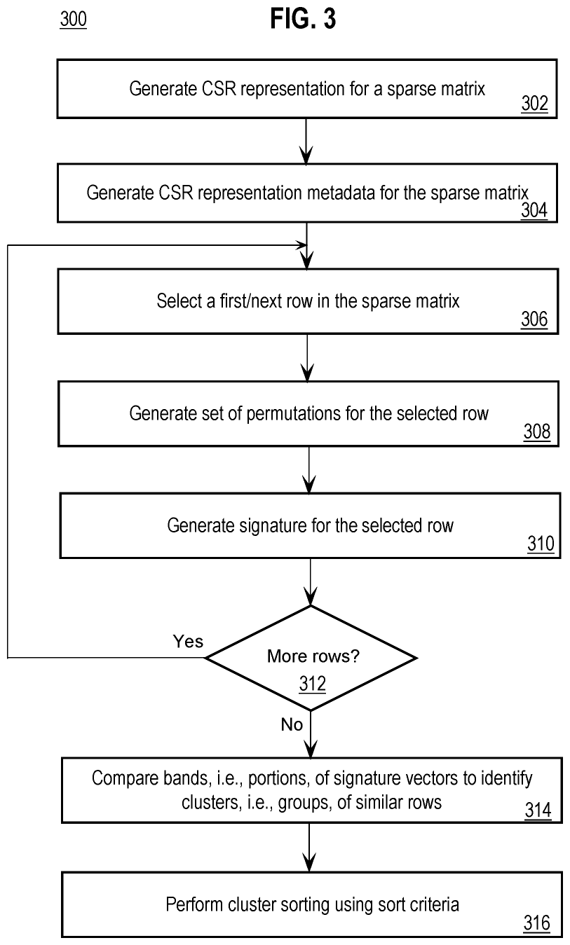

FIG. 3 is a flow diagram 300 that depicts an LSH approach for determining sparse matrix row similarity. The approach of FIG. 3 is performed, for example, as a preprocessing step before SpMV multiplication operations and the determined sparse matrix row similarity is then used to schedule SpMV multiplication operations. In step 302, a CSR representation for a sparse matrix is generated and in step 304, CSR representation metadata is generated for the sparse matrix, where the CSR representation metadata indicates the locations of non-zero values in the rows of the sparse matrix, as previously described herein.

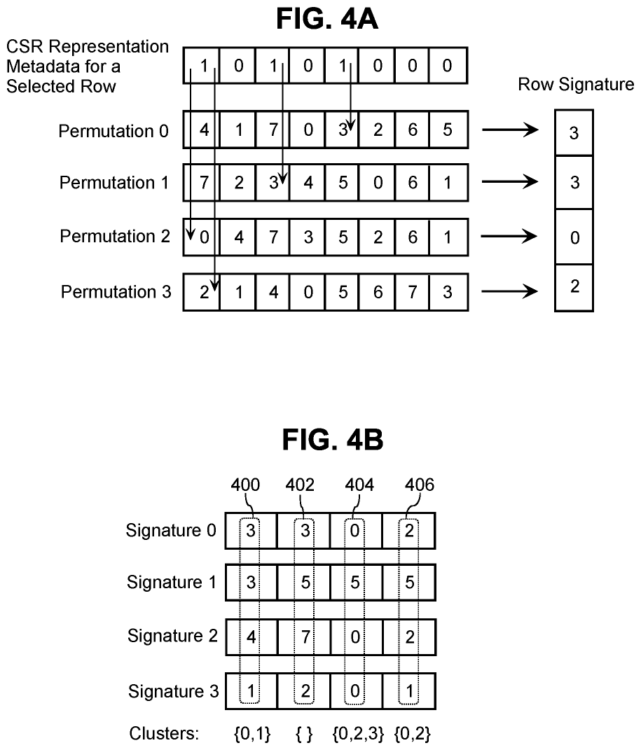

In step 306, a first or next row in the sparse matrix is selected. For example, the first row (row 0) in the sparse matrix is selected, but rows in the sparse matrix may be processed in any order. In step 308, a set of permutations is generated for the selected row. FIG. 4A depicts example CSR representation metadata for a selected row of a sparse matrix, a corresponding set of permutations, and a row signature. In this example, the CSR representation metadata has eight values for purposes of explanation, but implementations are applicable to rows of any length, e.g., sparse matrix rows with many thousands or more values. The CSR representation metadata for the row is processed using four random permutation functions to generate four corresponding permutations (“Permutation 0”-“Permutation 3”) that are the same length as the row. The permutation functions may be any function that permutes the CSR representation metadata for a row and generates a permutation. According to an implementation, the permutation functions used are such that they provide a uniform random distribution. Permutation values are not limited to the values in the CSR representation metadata for the row, i.e., “0s” and “1s” in the present example, and may include other values, as depicted in FIG. 4A. Example permutation functions include, without limitation, hash functions such as Minhash, etc. Implementations are applicable to any number of permutation functions.

In step 310, a signature is generated for the selected row in the sparse matrix. According to an implementation, a signature is a signature vector where the number of values in the signature vector is the number of permutations functions used, and where each value in the signature vector is a value from one of the permutations. Thus, in the example of FIG. 4A, the row signature vector has four values, one from each of the four permutations. According to an implementation, the smallest index value in each permutation that corresponds to a non-zero value in the CSR representation metadata for the row is used as the corresponding value in the signature vector. For example, in Permutation 0, the index values that correspond to non-zero values in the CSR representation metadata for the row are 4, 7 and 3, so the value 3 is used for the 0th value in the row signature vector, as indicated by the arrow. As another example, in Permutation 2, the index values that correspond to non-zero values in the CSR representation metadata for the row are 0, 7 and 5, so the value 0 is used for the 2nd value in the row signature vector, as indicated by the arrow. The same is also true for Permutations 1 and 3. Instead of using the smallest index value in each permutation that corresponds to a non-zero value in the CSR representation metadata for the row as the value in the signature vector, other values may be used, such as the largest index value from each permutation. Although steps 308 and 310 are depicted as separate steps for purposes of explanation, they may be performed by, for example, a single function that generates the permutation and the row signature.

In step 312, a determination is made whether there are more rows to process in the sparse matrix. If so, then control returns to step 306, where a next row is selected. Steps 306-312 are repeated until there are no further rows to process and control proceeds to step 314.

Once all the rows have been processed and a signature generated for each row in the sparse matrix, the signatures are compared to identify groups of similar rows referred to herein as “clusters.” In step 314, banding is used to compare portions of signatures to identify clusters of similar rows. FIG. 4B depicts signature vectors for four rows and using four bands to compare signatures. In this example, the signature vectors for the four rows are identified as “Signature 0” through “Signature 3” and there are four bands 400-406 that are one value wide, i.e., each band 400 has a width of one. The values in the signature vectors within each band are compared to identify a cluster. For example, for band 400, the first value of each of the four signature vectors are compared and the signatures with the identical first value are considered similar. For band 400, Signature 0 and 1 both have the same value “3” in the first location of their respective signature vectors and are considered similar. Thus, the cluster for band 400 is {0,1}. For band 402, none of the signatures have the same value in the second location of their signature vectors, so the cluster for band 402 is empty, i.e., { }. For band 404, Signatures 0, 2, 3 all have the same value “0” in the 3^{rd} location of their respective signature vectors and are considered similar. Thus, the cluster for band 404 is {0,2,3}. For band 406, Signatures 0 and 2 have the same value “2” in the 4^{th} location of their respective signature vectors and are considered similar. Thus, the cluster for band 406 is {0,1}.

Using the smallest band size of one as depicted in FIG. 4B results in a large number of clusters with lower quality results, since the signature vectors only need to have one matching value in the same location in their respective vector to be included in a cluster. Increasing band size reduces the number and/or size of clusters but increases quality, i.e., accuracy, since signatures must have a greater number of matching values to be included in a cluster. For example, FIG. 4C depicts the same four signature vectors of FIG. 4B, but using a larger band size. In this example, there are two bands 408, 410 that each have a width of two. Changing the band width from one to two decreases the number of non-empty clusters from three to one and also the size of the clusters. In FIG. 4B, rows 0 and 1, rows 0, 2, and 3, and row 0, 2 are found to be similar. In FIG. 4C there is only one cluster and only rows 0 and 2 are found to be similar since only the signature vectors for rows 0 and 2 have the same values in elements 2 and 3. Increasing the band size to maximum, i.e., to the size of the signature, a band size of four in the examples of FIGS. 4B and 4C, increases accuracy, but with a corresponding increase in computational cost. The signature size, i.e., the number of permutation functions used, and the band size are tunable parameters that determine accuracy and computational cost. As one example, a signature size of 4096 and a band size of 1024 are used by the processor 110, or an element external to the processor 110, to provide good performance characteristics in the form of high accuracy similarity at reasonable computational costs. According to an implementation, the signature within a band is processed, for example using a hash function, to generate a hash value that is compared to the corresponding hash values for other signatures. In the example of FIG. 4C, for Signature 0, the string “33” is processed using a hash function to generate a hash result. This hash result is used to cluster, i.e., group, the corresponding row for Signature 0, i.e., row 0, with other rows that have the same hash result. For example, a data structure may store various hash results and for each hash result, data that identifies rows for which a band within their respective signature vector has that hash result.

With the aforementioned banding approach rows may belong to multiple clusters. Therefore, ordering clusters provides a more efficient use of cached data when performing SpMV multiplication operations. Accordingly, in step 316, clusters are sorted using sort criteria to logically sort clusters and rows within clusters. As used herein, the term “sort” in the context of sorting clusters refers to logically organizing or prioritizing clusters to aid in scheduling SpMV multiplication operations to provide more efficient use of cached data on a processor, as described in more detail hereinafter. According to an implementation, sort criteria include cluster size, cluster density, and row density. Cluster size is the number of rows in a cluster. For example, in FIG. 4B, the cluster size of the cluster for band 400 (“Cluster 0”) is two, the cluster size of the cluster for band 402 (“Cluster 1”) is zero, the cluster size of the cluster for band 404 (“Cluster 2”) is three, and the cluster size of the cluster for band 406 (“Cluster 3”) is two. Row density refers to the number of non-zero values in a row. For example, in FIG. 4A, the CSR representation metadata indicates that the corresponding row has three non-zero values. Thus, the row density for this row is three. Cluster density refers to the total number of non-zero values in all of the rows in a cluster.

According to an implementation, clusters and rows are sorted based upon the following order of sort criteria: 1) cluster size; 2) cluster density; 3) cluster size+cluster density with cluster density used as a tie breaker; 4) cluster density+cluster size with cluster size used as a tie breaker; 5) cluster size+cluster density+intra-cluster sorting of rows based upon row density (in descending order); and 6) cluster density+cluster+intra-cluster sorting of rows based upon row density (in descending order). “Intra-cluster sorting” refers to sorting rows within clusters by row density, which improves performance when particular clusters have a large number of constituent rows.

For example, referring to FIG. 4B, when sorting based upon cluster size the clusters are ordered: Cluster 2, Cluster 0 and Cluster 3. Scheduling SpMV multiplication operations that access rows in the largest cluster first is beneficial because the largest number of similar rows will be accessed together or close in time, increasing the possibility to reuse cached column data, and accordingly cache hit performance, as described in more detail hereinafter. Since Cluster 0 and Cluster 3 each have two rows, cluster density, i.e., the total number of non-zero values in the constituent rows of each cluster, is used to determine the ordering between Cluster 0 and Cluster 3. Since in this example both Cluster 0 and Cluster 3 include row 0, the row density of rows 1 and 2 determines the ordering of Cluster 0 and Cluster 3 after Cluster 2. More specifically, if row 1 has more non-zero values than row 2, then the ordering of the clusters is Cluster 2, Cluster 0, Cluster 3. On the other hand, if row 2 has more non-zero values than row 1, then the ordering of the clusters is Cluster 2, Cluster 3, Cluster 0. Scheduling together SpMV multiplication operations that access clusters with higher density provides increased performance benefits because of a higher likelihood of similarity between the constituent rows in the clusters. According to an implementation, within a given cluster, the rows are sorted by row density from most dense (greatest number of non-zero values) to least dense.

E. Using Row Similarity to Improve Performance

According to an implementation, SpMV multiplication operations are scheduled based upon the similarity of rows in a sparse matrix. In the context of a processor 110 being a CPU, the scheduler 112 uses the CSR representation metadata 120 and/or the row similarity data 122 to create and/or schedule threads. For a single thread, accesses to similar rows in the sparse matrix are scheduled together or close in time. For example, suppose that thread TO is performing SpMV multiplication operations on multiple rows, such as calculating the dot product for rows 0-4 of sparse matrix A. As previously described herein with respect to FIG. 2D, rows 0 and 1 have high similarity. The scheduler 112 therefore schedules together accesses, such as loads and computation operations, for rows 0 and 1 for thread TO because of their high similarity. This increases the likelihood that the computations for row 1 will use the cached column data that was used for the computations for row 0. Scheduling accesses in this manner also reduces the likelihood of an eviction of the cache line that stores the column data used for these computations where, for example, an eviction policy is based upon recency of access. In contrast, the scheduler 112 does not necessarily schedule together the accesses to rows 1 and 2 for thread TO because of their low similarity, which does not provide the same increased temporal locality in column data as do the accesses to rows 0 and 1.

According to an implementation, multiple threads are scheduled in a manner so that they utilize the same cached data. For example, suppose that the SpMV multiplication operations for rows 0 and 1 of sparse matrix A are assigned to threads T1 and T3 in threads 114. Based upon the similarity of rows 0 and 1 as previously discussed, the scheduler 112 schedules threads T1 and T3 on the same core, such as Core 1 in FIG. 1, so that they share the same L1 cache. Alternatively, the scheduler 112 schedules threads T1 and T3 on different cores, such as Core 1 and Core 2, that share a cache, e.g., a L2 cache or as depicted in FIG. 1, a L3 cache. This allows threads T1 and T3 to reuse the same cached column data that is needed for the SpMV multiplication operations on rows 0 and 1 of sparse matrix A. According to an implementation, subsequent SpMV multiplication operations for similar rows are assigned to the same threads. For example, suppose that a next SpMV multiplication operation accesses row 3. The scheduler 112 references the row similarity data 122 and determines that row 3 has high similarity to row 0. Based upon this similarity in rows, the scheduler 114 assigns the next SpMV multiplication operation to thread T1. For a GPU or an accelerator, similar rows are mapped to individual work-items in a wavefront so that rows with high similarity are placed in the same wavefront or workgroup. In the context of row similarity determined using LSH as previously described herein, SpMV multiplication operations that access the rows in the top sorted cluster are scheduled together, followed by SpMV multiplication operations that access the rows in the next sorted cluster, etc. For rows that appear in multiple clusters, the first appearance in the highest ranked cluster is used for scheduling SpMV multiplication operations. According to an implementation, SpMV multiplication operations that access rows that do not have high similarity to other rows are scheduled after SpMV multiplication operations that access rows with high similarity to decrease the likelihood of interference, e.g., causing a cache eviction of column data that is used by SpMV multiplication operations that access rows with high similarity. Alternatively, SpMV multiplication operations that access rows that do not have high similarity are scheduled on threads and/or cores that use different caches than the SpMV multiplication operations that access rows with high similarity.

According to an implementation, similarity thresholds are used to schedule threads on particular processing elements to improve processing performance. Threads that access sparse matrix rows that have high similarity, i.e., similarity that satisfies (is greater than), a high similarity threshold are scheduled on cores with a high performance cache, such as Core 1 or Core 2 that each have an L1 cache. For example, suppose that the high similarity threshold is 0.75. As previously described herein with respect to FIG. 2D, rows 0 and 1 have a Cosine similarity of 0.82, which is greater than the high similarity threshold of 0.75. Rows 0 and 1 of sparse matrix A are therefore considered to have high similarity. The scheduler 112 schedules threads that access rows 0 and 1 of the sparse matrix A to execute on Core 1 or Core 2 since both of these cores have a high performance L1 cache. These threads would not be scheduled on a core that does not have an L1 cache.

According to an implementation, cache hints are used to specify particular processing elements. In the present example, the scheduler 112 causes a cache maintenance command to be issued to cause the L1 cache of Core 1 or Core 2 to be used for SpMV multiplication operations on rows 0 and 1 of sparse matrix A. According to another implementation, the scheduler 112 considers cache sizes when scheduling threads. In the prior example, the scheduler 112 schedules threads on particular processing elements, e.g., particular caches, based upon row similarity and also the amount of column data that can be stored in a particular cache to reduce cache misses. For example, the scheduler 112 verifies that the amount of data required to perform the SpMV multiplication operations for the threads can be stored in the cache, such as the L1 cache on Core 1 or Core 2. Further, the scheduler 112 can optimize thread assignment to cores, and corresponding caches, based upon data requirements of the threads.

Threads that access sparse matrix rows that have medium similarity, i.e., similarity that is below the high similarity threshold, but that satisfies (is greater than), a medium similarity threshold are scheduled on cores with a medium performance cache, such as the L2 cache on Core 1 or Core 2, which may also be a shared L2 cache. For example, suppose that the medium similarity threshold is 0.5. As previously described herein with respect to FIG. 2D, rows 0 and 3 have a Cosine similarity of 0.67, which is less than the high similarity threshold of 0.75 but greater than the medium similarity threshold of 0.5. Rows 0 and 3 of sparse matrix A are therefore considered to have medium similarity. The scheduler 112 schedules threads that access rows 0 and 3 of the sparse matrix A to execute on Core 1 or Core 2 using the L2 cache, and using a cache maintenance command as appropriate.

Threads that access sparse matrix rows that have low similarity, i.e., similarity below the medium similarity threshold are scheduled on cores with access to a low performance cache, such as an L3 cache. In this example, the threads are scheduled on either Core 1 or Core 2 since both of these cores have access to the L3 cache, and with a cache maintenance command as appropriate. Alternatively, threads that access sparse matrix rows with low similarity are scheduled in a manner so that the data accessed is not cached, for example via a “read through” maintenance command. In the GPU context, operations for sparse matrix rows with high similarity are placed in the same wavefront, while operations for sparse matrix rows with medium similarity are placed in the same work group or in a different work group that has access to the same shared cache, such as a L2 cache. Operations for sparse matrix rows with low similarity are not scheduled together.

According to an implementation, similarity thresholds are established for clusters based upon one or more of cluster size, cluster density, and row density. For example, the scheduler 112 is configured with high, medium and low similarity thresholds that are based upon cluster size. With this approach, rows in the largest clusters in a cluster hierarchy are characterized as having high similarity, rows in a middle group of clusters in the cluster hierarchy are characterized as having medium similarity, and rows in a low group of clusters in the cluster hierarchy are characterized as having low similarity. Similar thresholds may be based upon cluster density and row density.

According to an implementation, the scheduler 112 allocates SpMV multiplication operations among threads by identifying groups of SpMV multiplication operations that access similar rows, and then assigning each group of SpMV multiplication operations to one of the available threads 114. For example, the scheduler 112 reviews queued SpMV multiplication operations and determines that there are three groups of SpMV multiplication operations that each access two or more similar rows. The first group of SpMV multiplication operations may access two similar rows in a sparse matrix, the second group 10 similar rows in the sparse matrix, and the third group five similar rows in the sparse matrix. The scheduler 112 assigns each of the three groups of SpMV multiplication operations to the threads TO-T2, respectively. Other SpMV multiplication operations may be assigned to the other threads 114. The scheduler 112 is also configured to spawn additional threads if needed. For example, if there are only two available threads, the scheduler 112 spawns a new third thread so that three threads are available for the three groups of SpMV multiplication operations.

In some situations, the number of SpMV multiplication operations varies significantly across the groups, causing a workload imbalance across the threads, i.e., some threads may have a large number of SpMV multiplication operations while other threads have a very small number of SpMV multiplication operations. This can lead to significant inefficiencies in multi-threaded implementations when some threads have a heavy workload and other threads have comparatively less or no work.

To address this issue, in an implementation both row similarity and load balancing are used to provide a more efficient use of thread resources when performing SpMV multiplication operations. The scheduler 112 assigns SpMV multiplication operations to the threads 114 based upon row similarity as previously described herein, but also considers dynamic load balancing, i.e., the current load on the threads 114, to avoid particular threads from being overloaded or underloaded, adversely affecting performance. According to an implementation, the scheduler 112 manages work queues for the threads 114 and workload metrics that indicate the current workload on each of the threads 114. Suppose that a next set of SpMV multiplication operations accesses rows in a sparse matrix that have high similarity to the rows currently being accessed by SpMV multiplication operations assigned to thread T2. Considering row similarity alone, these would normally be assigned to thread T2 but according to an implementation, if the current workload of thread T2 exceeds a workload threshold, then the next set of SpMV multiplication operations are instead assigned to one or more other threads whose current workload is below the workload threshold, even though data reuse may be lower. The workload threshold may be empirically determined and configured in the scheduler 112. According to an implementation, the next set of SpMV multiplication operations is assigned to other threads that are currently accessing rows that are most similar to the rows accessed by the next set of SpMV multiplication operations. In the context of a GPU, the hardware and/or firmware on the scheduler uses the CSR representation metadata 120 and/or the row similarity data 122 to dynamically schedule rows to particular work groups on particular compute units, which may also include using load balancing metrics.

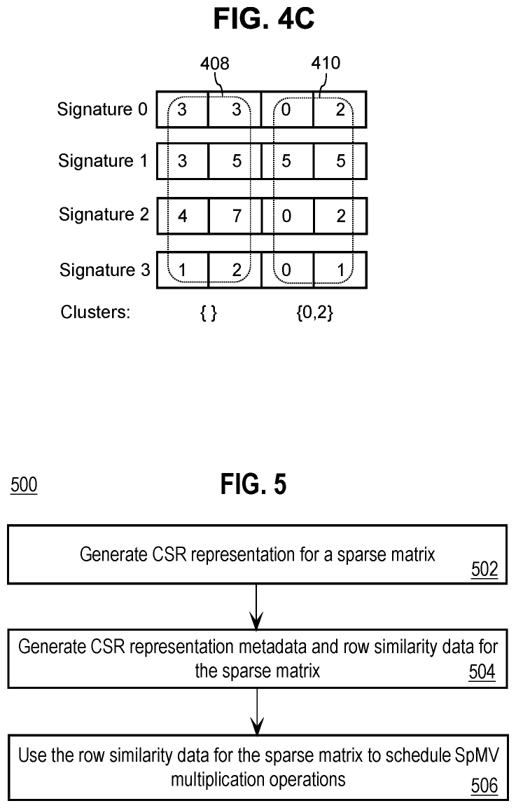

FIG. 5 is a flow diagram 500 that depicts an approach for performing SpMV multiplication using sparse matrix row similarity. In step 502, a CSR representation is generated for a sparse matrix. For example, the processor 110 or another element generates a CSR representation of sparse matrix A as depicted in FIG. 2B. In step 504, CSR representation metadata and row similarity data are generated for the sparse matrix. For example, the processor 110 or another element generates the CSR representation metadata 120 and the row similarity data 122. The CSR representation metadata 120 may indicate the locations of non-zero values as depicted in FIG. 2C, or the cache locations of column data as depicted in FIG. 2F. The row similarity data 122 indicates the similarity between rows in the sparse matrix A, as determined using Cosine similarity, Jaccard similarity, or another approach for determining similarity between sparse matrix rows. In step 506, the row similarity data 122 is used to schedule SpMV multiplication operations as described herein.

What is claimed is:

1. A processor comprising:
a scheduler configured to schedule sparse matrix multiplication operations based at least upon similarity of two or more rows in a sparse matrix used for the matrix multiplication operations.

2. The processor of claim 1, wherein the similarity of the two or more rows in the sparse matrix used for the sparse matrix multiplication operations is based upon locations of non-zero values in the two or more rows of the sparse matrix.

3. The processor of claim 2, wherein the locations of non-zero values in the two or more rows in the sparse matrix are determined during generation of a Compressed Sparse Row (CSR) representation of the sparse matrix.

4. The processor of claim 1, wherein the similarity of the two or more rows in the sparse matrix used for the sparse matrix multiplication operations is based upon locations of cached data used for the matrix multiplication operations.

5. The processor of claim 1, wherein the similarity of the two or more rows in the sparse matrix used for the sparse matrix multiplication operations is determined using one or more of Cosine similarity or Jaccard similarity of the two or more rows in the sparse matrix.

6. The processor of claim 1, wherein the similarity of the two or more rows in the sparse matrix used for the sparse matrix multiplication operations is determined by:
determining a signature for each row from the two or more rows, and
determining that values in one or more portions of the signature for each row from the two or more rows are the same.

7. The processor of claim 6, wherein the signature for each row from the two or more rows is a signature vector and is determined by:
processing, using a plurality of permutation functions, metadata for the row to generate a plurality of permutations, wherein the metadata for the row indicates locations of non-zero values in the row, and
selecting, from each permutation from the plurality of permutations, a value that is included in the signature vector.

8. The processor of claim 1, wherein the scheduler is further configured to:
determine a signature for each row from the two or more rows,
compare one or more portions of the signatures for the two or more rows to identify a plurality of clusters of similar rows, and
sort the plurality of clusters based upon one or more of the number of rows in each cluster from the plurality of clusters or a total number of non-zero values in the rows of each cluster from the plurality of clusters.

9. The processor of claim 8, wherein the scheduler is further configured to:
sort two or more rows within a particular cluster, from the plurality of clusters, based upon a number of non-zero values in each of the two or more rows within the particular cluster.

10. The processor of claim 1, wherein accesses to data in the two or more rows in the sparse matrix are scheduled together.

11. The processor of claim 1, wherein the scheduler is further configured to cause two or more different threads accessing the two or more rows in the sparse matrix to execute on one or more of a core with a cache, or on two or more cores with a shared cache.

12. The processor of claim 11, wherein the two or more rows in the sparse matrix have a similarity that satisfies a similarity threshold.

13. The processor of claim 1, wherein the scheduler is further configured to assign the sparse matrix multiplication operations to one or more of: one or more threads or one or more wavefronts based upon the similarity of the two or more rows in the sparse matrix and load balancing.

14. The processor of claim 1, wherein the processor is one or more of a central processing unit, a graphics processing unit, or a programmed controller.

15. A method comprising:
scheduling, by a scheduler for a processor, sparse matrix multiplication operations based at least upon similarity of two or more rows in a sparse matrix used for the matrix multiplication operations.

16. The method of claim 15, wherein the similarity of the two or more rows in the sparse matrix used for the sparse matrix multiplication operations is based upon locations of non-zero values in the two or more rows of the sparse matrix.

17. The method of claim 15, wherein the similarity of the two or more rows in the sparse matrix used for the sparse matrix multiplication operations is based upon locations of cached data used for the matrix multiplication operations.

18. The method of claim 15, wherein the similarity of the two or more rows in the sparse matrix used for the sparse matrix multiplication operations is determined by:
determining a signature for each row from the two or more rows, and
determining that values in one or more portions of the signature for each row from the two or more rows are the same.

19. The method of claim 15, further comprising:
determining, by the scheduler, a signature for each row from the two or more rows,
comparing, by the scheduler, one or more portions of the signatures for the two or more rows to identify a plurality of clusters of similar rows, and
sorting, by the scheduler, the plurality of clusters based upon one or more of the number of rows in each cluster from the plurality of clusters or a total number of non-zero values in the rows of each cluster from the plurality of clusters.

20. The method of claim 15, wherein accesses to data in the two or more rows in the sparse matrix are scheduled together.
